(19) United States
(12) Patent Application Publication
(10) Pub. No.: US 2026/0110802 A1
(43) Pub. Date: Apr. 23, 2026

(54) METHOD FOR GENERATING TRAINING DATA FOR A MACHINE LEARNING MODEL

(71) Applicant: Robert Bosch GmbH, Stuttgart (DE)

(72) Inventors: Eddy ILG, Nürnberg (DE); Jonas KAELBLE, Schramberg (DE); Maxim TATARCHENKO, Berlin (DE); Sascha WIRGES, Buehl (DE)

(21) Appl. No.: 19/361,404

(22) Filed: Oct. 17, 2025

(30) Foreign Application Priority Data
Oct. 18, 2024 (DE) 10 2024 210 117.6

(51) Int. Cl. G01S 17/931; B60W 60/00; G01S 17/86; G01S 17/89; G06V 10/764; G06V 10/774; G06V 10/80; G06V 20/56

(52) U.S. Cl. CPC G01S 17/931; G01S 17/86; G01S 17/89; G06V 10/764; G06V 10/774; G06V 10/809; G06V 20/588; B60W 60/001; B60W 2420/403; B60W 2420/408

(57) ABSTRACT

A method for generating training data for a machine learning model. The method includes: providing LIDAR point clouds, each of which is assigned to a point in time of a plurality of successive points in time, wherein each point of each LIDAR point cloud represents a particular object class of a plurality of object classes; for each LIDAR point cloud: ascertaining a transmission grid map in spherical coordinate space, wherein each voxel of the transmission grid map indicates how many rays pass through the voxel before they are reflected at a point in the LIDAR point cloud; ascertaining a reference transmission grid map in Cartesian coordinate space assigned to a reference point in time of the plurality of points in time; for each of the plurality of object classes: for each LIDAR point cloud, ascertaining a reflection grid map associated with the object class.

### BACKGROUND INFORMATION

In at least partially automated (e.g., autonomous) driving, a vehicle can take over driving tasks autonomously. A detailed understanding of the surrounding area of the vehicle is required in order to ensure safe operation. For this purpose, the surrounding area can be recorded and evaluated as sensor data by using various sensors, such as LIDAR sensors and cameras. The sensor data can be evaluated, for example, using a machine learning model. To do this, it is first necessary to train the machine learning model with appropriate training data. The accuracy with which the machine learning model can then recognize the surrounding area based on the sensor data, and thus the level of safety ensured during autonomous driving, depends on the training data. Due to the limited amount of information in LIDAR data, this accuracy is usually very limited.

### SUMMARY

The present invention relates to a method for generating training data for a machine learning model, whereby a machine learning model trained by means of these training data can more accurately recognize the surrounding area of a robot device, such as the vehicle. These training data contain a semantic occupancy grid map of the surrounding area of the robot device, which is generated based on annotated (i.e., labeled) LIDAR point clouds. Various aspects of the present invention relate to a method for generating training data for a machine learning model, the method comprising: providing a plurality of annotated LIDAR point clouds representing a (dynamic) surrounding area of a robot device, of which each annotated LIDAR point cloud is assigned to a point in time of a plurality of successive points in time, wherein each point of each annotated LIDAR point cloud represents a particular object class of a plurality of object classes; for each annotated LIDAR point cloud of the plurality of annotated LIDAR point clouds: ascertaining a transmission grid map (of the surrounding area of the robot device) in spherical coordinate space, wherein each voxel (of a plurality of voxels) of the transmission grid map indicates how many rays pass through the voxel before they are reflected at a point of the annotated LIDAR point cloud; ascertaining a reference transmission grid map in Cartesian coordinate space associated with a reference point in time of the plurality of points in time by: transforming the voxels of each transmission grid map by using motion information indicating how objects represented by the plurality of annotated LIDAR point clouds move at the successive points in time such that the position of said voxels corresponds to the position at the reference point in time, and by transforming them from spherical coordinate space to Cartesian coordinate space, wherein each voxel (of a plurality of voxels) of the reference transmission grid map indicates how many rays pass through the voxel on average before being reflected; for each object class of the plurality of object classes: for each annotated LIDAR point cloud of the plurality of annotated LIDAR point clouds, ascertaining a reflection grid map (of the surrounding area of the robot device) associated with the object class, wherein each voxel (of a plurality of voxels) of the reflection grid map (associated with the object class) indicates how many points representing the object class are arranged in the voxel (by way of illustration, how many reflections for this object class originated from the voxel), ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming them from spherical coordinate space to Cartesian coordinate space, wherein each voxel (of a plurality of voxels) of the object class-specific reference reflection grid map indicates how many points representing the object class are arranged on average in the voxel; and, by using the reference transmission grid map and each object class-specific reference reflection grid map, ascertaining a (three-dimensional) (semantic) ground truth occupancy grid map (of the surrounding area of the robot device at the reference point in time) by means of evidence theory, wherein each voxel (of a plurality of voxels) of the (semantic) ground truth occupancy grid map indicates whether the voxel is occupied by an object and, if the voxel is occupied by an object, indicates the object class.

Various exemplary embodiments of the present invention are specified below.

Example 1 is the method for generating training data for a machine learning model as described above.

Example 2 is configured according to example 1, wherein (precisely) one object class of the plurality of object classes indicates that an object type is unknown, and each other object class of the plurality of object classes indicates a particular object type; and wherein the ground truth occupancy grid map, if the voxel is occupied by an object, indicates the object type.

This also allows an object type to be assigned to each voxel in the LIDAR data that is occupied, for example, by a non-labeled object. By way of illustration, non-labeled, unknown objects can also be classified (i.e., labeled) in the ground truth occupancy grid map.

Example 3 is configured according to example 1 or 2, wherein transforming from spherical coordinate space to Cartesian coordinate space comprises, for each voxel: normalizing a (reflection or transmission) number indicated by the voxel to a ratio between a volume of the voxel in spherical coordinate space and a volume of the voxel in Cartesian coordinate space. This allows the different sizes of the voxels in spherical coordinate space and Cartesian coordinate space to be taken into account.

Example 4 is configured according to one of examples 1 to 3, wherein ascertaining the (semantic) ground truth occupancy grid map by means of evidence theory comprises: ascertaining the (semantic) ground truth occupancy grid map by means of evidence theory with a particular hypothesis for: each object class of the plurality of object classes, a free state, an occupied state, and an uncertainty.

Example 5 is configured according to examples 2 and 4, wherein ascertaining the (semantic) ground truth occupancy grid map by means of evidence theory for each voxel comprises: ascertaining (according to evidence theory) a particular plausibility for each other object class of the plurality of object classes; ascertaining (according to a belief of evidence theory) whether or not the voxel is occupied by an object; and if it is ascertained that the voxel is occupied by an object, ascertaining the other object class having the greatest plausibility as the object class indicated by the voxel.

By means of examples 4 and 5, the object class can be ascertained based on the object class-specific hypothesis, for example, even for previously non-labeled objects.

Example 6 is a method for training a machine learning model that is configured to output an occupancy grid map in response to an input of camera images, the method comprising: generating the ground truth occupancy grid map according to one of claims 1 to 5; providing camera images representing the (dynamic) surrounding area of the robot device at the reference point in time (e.g., in a panoramic view); and training the machine learning model by using the camera images as input and the ground truth occupancy grid map as ground truth output.

Example 7 is a method for controlling a robot device (e.g., an at least partially automated vehicle), the method comprising: receiving camera images representing the surrounding area of the robot device (e.g., in a panoramic view); ascertaining an occupancy grid map of the surrounding area of the robot device by using the machine learning model trained according to claim 6; ascertaining, by using the occupancy grid map, a control trajectory for controlling the robot device; and controlling the robot device according to the control trajectory.

Example 8 is a data processing unit that is configured to carry out the method according to one of examples 1 to 6.

Example 9 is a control device that is configured to carry out the method according to example 7.

Example 10 is a robot device (e.g., an at least partially automated vehicle) comprising: the control device according to example 9; and a plurality of cameras for capturing the camera images.

Example 11 is a computer program comprising commands that, when executed by a processor, cause the processor to carry out the method according to one of examples 1 to 7.

Example 12 is a computer-readable medium that stores commands that, when executed by a processor, cause the processor to carry out the method according to one of examples 1 to 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows an at least partially automated vehicle according to various aspects of the present invention.

FIG. 2 shows a flowchart of a method for generating training data for a machine learning model according to various aspects of the present invention.

FIG. 3 shows various aspects of the method for generating training data for a machine learning model according to various aspects of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be carried out without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

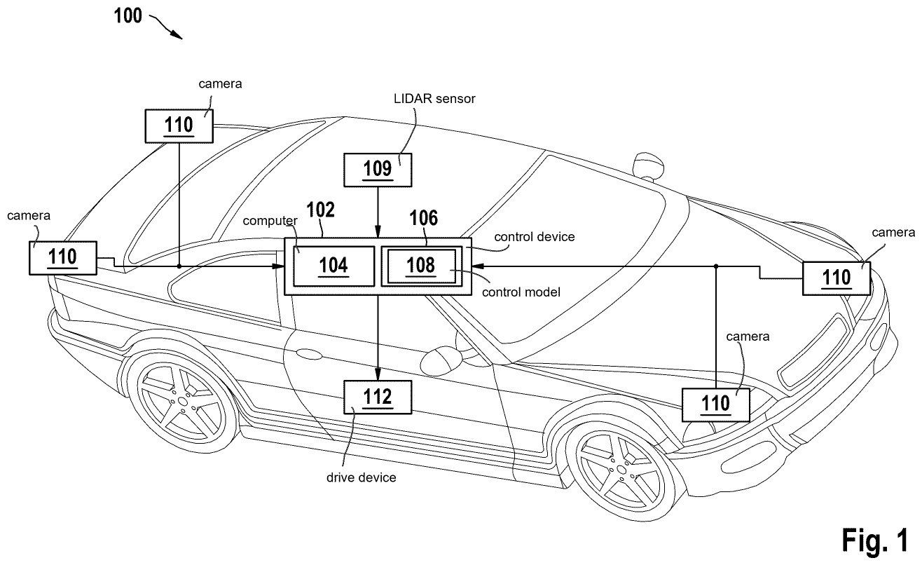

FIG. 1 shows an at least partially automated vehicle 100 according to various aspects. The at least partially automated vehicle 100 shown in FIG. 1 and described herein for illustrative purposes is an exemplary computer-controlled device. Although various aspects of the computer-implemented method are described herein with reference to the vehicle 100, it is understood that this is for illustrative purposes and that any other type of computer-controlled device may use the computer-implemented method. Another computer-controlled device may, for example, be a robot device (short: robot), such as an industrial robot (e.g., in the form of a robot arm for moving, assembling or processing a workpiece, for removing containers, etc.), a manufacturing robot, a maintenance robot, a household robot, a medical robot, a household appliance, a production machine, a personal assistant, an access control system, etc., as well as any other type of robot device.

For controlling the vehicle 100, the vehicle 100 can comprise a (vehicle) control device 102 that is configured to realize an interaction of the vehicle 100 with its surrounding area according to a control program. The term “control device” can be understood as any type of logical implementation unit that can include, for example, a circuit and/or a processor capable of executing software, firmware or a combination thereof stored in a storage medium, and that can issue instructions, e.g., to an actuator in the present example. The control device can be configured, for example, by program code (e.g. software) to control the operation of a system, in the present example a robot.

In the present example, the control device 102 can comprise a computer 104 and a memory 106 that stores code and data on the basis of which the computer 104 controls the vehicle 100. According to various aspects, the control device 102 can control the vehicle 100 based on a control model 108 stored in the memory 106.

In order to be able to control a driving task of the vehicle 100, the control device 102 can use sensor data that represent a surrounding area of the vehicle 100. For this purpose, the vehicle 100 can comprise a plurality of sensors 109, 110, each of which can provide respective sensor data that represent at least part of the surrounding area of the vehicle 100. A sensor of the plurality of sensors 109, 110 can be, for example, an imaging sensor and/or a proximity sensor, such as a camera (e.g., a standard camera, a digital camera, an infrared camera, a stereo camera, etc.), a radar sensor, a LIDAR sensor, an ultrasonic sensor, etc. One of the plurality of sensors 109, 110 can be configured to capture an image that shows at least part of the surrounding area of the vehicle 100. An image can be an RGB image, an RGB-D image or a depth image (also referred to as a D-image). A depth image described herein may be any type of image that includes depth information. Conceptually, a depth image can comprise 3-dimensional information about one or more objects in the surrounding area of the vehicle 100. For example, a depth image described herein may include a point cloud provided by a LIDAR sensor and/or a radar sensor. A depth image can, for example, be an image with depth information provided by a LIDAR sensor. According to various aspects, the vehicle 100 can comprise at least one LIDAR sensor 109 and at least one camera 110. It is understood that the vehicle 100 can further comprise other sensors, such as a Global Navigation Satellite System (GNSS, e.g., Global Positioning System, GPS), a speed sensor, an accelerometer, an altimeter sensor, a gyroscope, etc., and the control device 102 can also use sensor data provided by these other sensors to control the vehicle 100. The control device 102 can be configured to control the vehicle 100 in response to an input of the sensor data to the control model 108 based on an output of the control model 108. The control model 108 can have a machine learning model for detecting objects in the surrounding area of the vehicle 100 and can control a driving task depending on the detected objects.

The vehicle 100 can comprise a drive device 112 for driving the vehicle 100. The control device 102 can be configured to ascertain a control parameter for controlling the vehicle 100 by using an output of the control model 108. The control device 102 can be configured to control the operation of the vehicle 100 (e.g., by controlling the drive device 112 by means of a control signal) according to the control parameters.

The at least partially automated vehicle 100 may be an automated vehicle or an autonomous vehicle. A vehicle's autonomy level can be ascertained or specified by an SAE (Society of Automotive Engineers) level (e.g., as defined in SAE J3016). For example, the at least partially automated vehicle 100 can be a partially automated vehicle (according to SAE Level 2), a highly automated vehicle (according to SAE Level 3), a fully automated vehicle (according to SAE Level 4) or an autonomous vehicle (according to SAE Level 5).

An at least partially automated vehicle can generally perform driving tasks autonomously. In order to ensure the safety of passengers and other road users (e.g., cyclists, pedestrians, etc.), systems that perform autonomous driving tasks must be highly safety-critical.

To ensure safe operation, a detailed understanding of the surrounding area of the vehicle 100 is required. For this purpose, for example, LIDAR sensors and/or camera sensors can be used and, based on their sensor data, an occupancy grid map of the surrounding area of the vehicle 100 can be generated. LIDAR sensors (e.g., in conjunction with cameras) are often used because they have low, distance-dependent measurement error.

However, LIDAR sensors are significantly more expensive than cameras. Consequently, costs could be significantly reduced if the occupancy grid map of the surrounding area of the vehicle 100 is generated exclusively from camera images. For this purpose, it is necessary to generate meaningful ground truth occupancy grid maps, which can then be used to train a machine learning model to map the camera images onto an occupancy grid map.

In this regard, Kälble et al.: “Accurate Training Data for Occupancy Map Prediction in Automated Driving Using Evidence Theory,” arXiv: 2405.1057, 2024 (hereinafter referred to as reference [1]) describes the generation of occupancy grid maps from LIDAR data by means of evidence theory, wherein the occupancy grid maps exclusively represent geometric information from the surrounding area of the vehicle 100 (a voxel is either “occupied” or “unoccupied,” i.e., “free”).

However, controlling the at least partially automated vehicle 100 requires not only a geometric understanding of the surrounding area of the vehicle 100, but also the semantic context, i.e., whether an object is a static object, such as a house, a tree, etc., or a dynamic object, such as a pedestrian, a cyclist, another vehicle, etc.

The method described here makes it possible to generate a semantic ground truth occupancy grid map by means of evidence theory, i.e., an occupancy grid map that also indicates an object class for each occupied voxel of the occupancy grid map. For various aspects that are independent of the object class, please refer to reference [1].

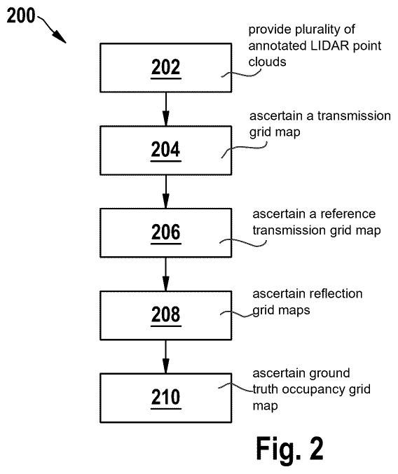

FIG. 2 shows a flowchart of a (computer-implemented) method 200 for generating training data for a machine learning model according to various aspects.

The method 200 can comprise (in 202) providing a plurality of annotated LIDAR point clouds representing a (dynamic) surrounding area of a robot device (e.g., the vehicle 100). Each annotated LIDAR point cloud of the plurality of annotated LIDAR point clouds can be assigned to a point in time of a plurality of successive points in time. Each point of each annotated LIDAR point cloud can represent a particular object class of a plurality of object classes.

The method 200 can comprise (in 204) ascertaining a transmission grid map (of the surrounding area of the robot device) in spherical coordinate space for each annotated LIDAR point cloud of the plurality of annotated LIDAR point clouds. Each voxel (of a plurality of voxels) of the transmission grid map can indicate how many rays pass through the voxel before being reflected at a point in the annotated LIDAR point cloud.

The method 200 can comprise (in 206) ascertaining a reference transmission grid map in Cartesian coordinate space assigned to a reference point in time of the plurality of points in time by: transforming the voxels of each transmission grid map by using motion information indicating how objects represented by the plurality of annotated LIDAR point clouds move at the successive points in time such that the position of said voxels corresponds to the position at the reference point in time, and by transforming them from spherical coordinate space to Cartesian coordinate space, wherein each voxel (of a plurality of voxels) of the reference transmission grid map indicates how many rays pass through the voxel on average before being reflected.

The method 200 can comprise (in 208), for each object class of the plurality of object classes: for each annotated LIDAR point cloud of the plurality of annotated LIDAR point clouds, ascertaining a reflection grid map (of the surrounding area of the robot device) associated with the object class, wherein each voxel (of a plurality of voxels) of the reflection grid map (associated with the object class) indicates how many points representing the object class are arranged in the voxel (by way of illustration, how many reflections for this object class originated from the voxel); and ascertaining an object class-specific reference reflection grid map in Cartesian coordinate space associated with the reference point in time by: transforming the voxels of each reflection grid map associated with the object class by using the motion information such that the position of said voxels corresponds to the position at the reference point in time, and by transforming them from spherical coordinate space to Cartesian coordinate space, wherein each voxel (of a plurality of voxels) of the object class-specific reference reflection grid map indicates how many points representing the object class are arranged on average in the voxel.

The method 200 can comprise (in 210), by using the reference transmission grid map and each object class-specific reference reflection grid map, ascertaining a (three-dimensional) (semantic) ground truth occupancy grid map (of the surrounding area of the robot device at the reference point in time) by means of evidence theory. Each voxel (of a plurality of voxels) of the (semantic) ground truth occupancy grid map can indicate whether the voxel is occupied by an object and, if the voxel is occupied by an object, can indicate the object class.

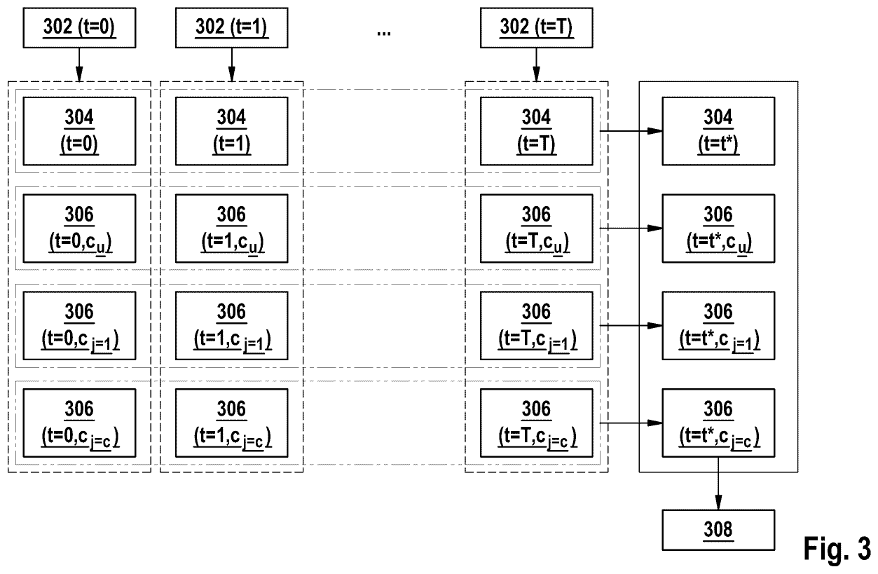

Various aspects of the method 200 are described in more detail below with reference to FIG. 3. For illustration purposes, various aspects are described by way of example for the vehicle 100. It is understood that this is for illustrative purposes and that the robot device can also be any other type of (e.g., dynamic) robot device whose surrounding area is to be detected.

In 202, the plurality of annotated LIDAR point clouds 302 can be provided, of which each annotated LIDAR point cloud 302(t) is assigned to a point in time, t, of the plurality of successive points in time, t=0 to T. Here, T can be any integer greater than one.

A LIDAR point cloud can generally contain a plurality of (three-dimensional, 3D) points. Each point in the LIDAR point cloud can represent the reflection, from a specific object, of a light beam (e.g., a laser beam) emitted by a light source (e.g., mounted on the vehicle 100). By way of illustration, each point in the LIDAR point cloud can be associated with a specific object. An annotated LIDAR point cloud (also called a labeled LIDAR point cloud) can indicate, for a plurality of points (e.g., all or a subset) of the multitude of points, what object it is (i.e., what object type the object has). This can be indicated by means of the plurality of object classes.

According to various aspects, precisely one (unknown) object class, cᵤ, can indicate that the object type is unknown. All other (object type) object classes, c_{i=1 to C} (where C can be any integer greater than or equal to one), can be assigned a particular object type, i. Consequently, each point of the plurality of points in the annotated LIDAR point cloud can be assigned an object type object class, cᵢ, and all other points in the annotated LIDAR point cloud can be assigned the unknown object class, cᵤ. Consequently, the plurality of object classes can have C+1 object classes.

Furthermore, in 202, motion information can be provided indicating how each object of the plurality of objects moves at the successive points in time, t=0 to T.

In 204, for each annotated LIDAR point cloud 302(t), the particular (spherical, sph) transmission grid map 304(t), (with transmissions

$${t}_{t}^{sph} ( ρ , ϕ , θ )$$

for each voxel (ρ,φ,θ), in spherical coordinate space can be ascertained. In 208, corresponding (spherical) reflection grid maps, (with reflections

$${r}_{t , c}^{sph} ( ρ , ϕ , θ ) = {r}_{t , {c}_{i = 1 to C}}^{sph} ( ρ , ϕ , θ ) + {r}_{t , {c}_{u}}^{sp} ( ρ , ϕ , θ )$$

for each voxel (ρ,φ,θ)), in spherical coordinate space can be generated. However, for each object class, cᵤ, and cᵢ, of the plurality of object classes, C+1 (cᵤ and c_{i=1 to C}), a particular reflection grid map 306(t, c) is generated. Consequently, a number of (C+1)*(T+1) reflection grid maps can be generated. Spherical coordinates represent the LIDAR data in an advantageous way.

Each grid map described herein (e.g., transmission grid map, reflection grid map, occupancy grid map) can have a plurality of (e.g., 3D) voxels. By way of illustration, the surrounding area of the vehicle 100 can be divided into a plurality of (3D) voxels (unambiguous, i.e., non-overlapping voxels).

Each voxel (with reflections

$${r}_{t , c}^{sph} ( ρ , ϕ , θ ) )$$

a reflection grid map 306(t, c) can indicate how many points representing the object class, c, are arranged in the voxel. A voxel can indicate how many reflections,

$$( {r}_{t , c}^{sph} ( ρ , ϕ , θ ) ) ,$$

for this object class, c, originated from which voxel. Each voxel of a transmission grid map 304(t) can indicate how many rays

$$( {t}_{t}^{sph} ( ρ , ϕ , θ ) , )$$

pass through the voxel (ρ,φ,θ) before they are reflected at a point in the annotated LIDAR point cloud. The number of transmissions of a voxel at position (ρ,θ,φ) can be ascertained according to:

$${t}_{t}^{sph} ( ρ , ϕ , θ ) = {\sum }_{{ρ}^{′} > ρ} {\underbrace{( {r}_{t , {c}_{u}}^{sph} ( {ρ}^{′} , ϕ , θ ) + {{\sum }^{C}}_{i = 1} {r}_{t , {c}_{i}}^{sph} ( {ρ}^{′} , ϕ , θ ) )}}_{Sum of all reflections for {ρ}^{′} > ρ}$$

The number of transmissions can be the sum of all reflections with a radius ρ′ that is larger than the radius ρ of the position (ρ,θ,φ) of the voxel. By way of illustration, these rays pass through the voxel before they are reflected.

According to various aspects, the number of reflections,

$${r}_{t , c}^{sph} ( ρ , ϕ , θ ) ,$$

of each voxel (ρ,φ,θ) of a reflection grid map 306(t, c) can be normalized to the volume of the voxel. The normalized number of reflections of a voxel (ρ,φ,θ) can be indicated as

$${\hat{r}}_{t , c}^{sph} ( ρ , ϕ , θ ) .$$

Accordingly, the number of transmissions,

$${t}_{t}^{sph} ( ρ , ϕ , θ ) ,$$

of each voxel (ρ,φ,θ) of a transmission grid map 304(t) can be normalized to the volume of the voxel. The normalized number of transmissions of a voxel (ρ,φ,θ) can be indicated as

$${\hat{t}}_{t}^{sph} ( ρ , ϕ , θ ) .$$

In this way, it can be taken into account that the voxels in spherical coordinate space have different volumes (whereas in Cartesian coordinate space they have the same volume).

In 206, the reference transmission grid map 304(t*) in Cartesian coordinate space can be ascertained for the reference point in time, t*, of the plurality of successive points in time, t=0 . . . . T. Accordingly, in 208, for each object class, c, of the plurality of object classes, C+1, an object class-specific reference reflection grid map 306(t*, c) is generated at the reference point in time, t*.

As described herein, the motion information can indicate how the objects represented by the plurality of annotated LIDAR point clouds move at the successive points in time. Using the motion information, the (transmission or reflection) grid maps of the other points in time, t=0 . . . . T \t*, can be transformed such that the position of each object represented therein corresponds to the position at the reference point in time, t*. Then, the voxels (ρ,φ,θ) (e.g., with the normalized number) of a particular grid map can be transformed to Cartesian coordinate space (see, for example, reference [1]). Each voxel (x,y,z) in Cartesian coordinate space can then indicate an average value of the number (of reflections or transmissions) over the voxels of all points in time, t=0 . . . . T, that overlap at the reference point in time, t*.

By way of illustration, each voxel t_{t*}(x,y,z) of the reference transmission grid map 304(t*) can be ascertained according to:

$${t}_{t *} ( x , y , z ) = \frac{1}{T} {\sum }_{t = 1}^{T} g ( {\hat{t}}_{t}^{sph} ( ρ , ϕ , θ ) )$$

where g represents the motion compensation.

Accordingly, each voxel r_{t*,c}(x,y,z) of an object class-specific reference reflection grid map 306(t*, c) can be ascertained according to:

$${r}_{t * , c} ( x , y , z ) = \frac{1}{T} {\sum }_{t = 1}^{T} g ( {\hat{r}}_{t , c}^{s p h} ( ρ , ϕ , θ ) )$$

In 210, using the reference transmission grid map 304(t*) and all object class-specific reference reflection grid maps 306(t*, c=cᵤ and c_{i=1 to C}), the ground truth occupancy grid map 308 can be ascertained by means of evidence theory (also called Dempster-Shafer theory).

To generate occupancy grid maps, a Bayesian interpretation of probabilities is often used, wherein the state of a voxel is modeled as a Bernoulli-distributed random variable and can be either occupied or free. Because the state of the voxel is defined by a single probability, such a model neither takes into account the uncertainty in the measurements used to estimate the state nor handles conflicts between different measurements. In contrast, the use of evidence theory can take this uncertainty into account.

Each voxel (x, y, z) of the ground truth occupancy grid map 308 can indicate whether the voxel is occupied by an object or not. If the voxel (x, y, z) is indicated as being occupied by an object, the ground truth occupancy grid map 308 can further indicate the object type, i. By way of illustration, points that have the unknown object class, cᵤ, in the annotated LIDAR point cloud, can be assigned to an object type object class, cᵢ, in the ground truth occupancy grid map 308.

In evidence theory, a belief mass m(ω) is assigned to each hypothesis in a power set 2^{Ω} of the frame of discernment (FOD) Ω, wherein the sum of all hypotheses is 1: m:2^{Ω}→[0,1] with Σ_{X∈2}_{^{Ω}} m(X)=1. The belief, bel, of a hypothesis ω is the sum of all belief masses m(ω) according to bel(ω)=Σ_{X⊆ω} m(X)≤prob(ω). This serves as a lower bound on the probability that a given hypothesis is true. The plausibility, pl, is an upper bound on the probability of ω and is defined as one minus the sum of all belief masses that are mutually exclusive of ω, i.e., these have an empty intersection with ω according to: pl(ω)=1−Σ_{X∩ω≠Ø} m(X)=Σ_{X∩ω≠Ø} m(X)≥prob(ω).

According to various aspects, a particular hypothesis is used for: each object class of the plurality of object classes (i.e., for each object type object class, cᵢ, and for the unknown object class, cᵤ), a free state, an occupied state, and an uncertainty. These are shown in the table below:

| Description | Hypothesis ω | Measurement z(ω) |
|---|---|---|
| Free | [symbol] = {f} | z( [symbol] ) = αₜ\hat{t}ₜ* |
| Occupied with the object type | [symbol] = {cᵢ} | z( [symbol] ) = αᵣ\hat{r}ₜ*_{, c}_{ᵢ} |
| object class i | | |
| Occupied with the unknown | [symbol] = {u} | z( [symbol] ) = 0 |
| object class | | |
| Occupied | [symbol] = (Uᵢ [symbol] ) ∪ [symbol] | z( [symbol] ) = αᵣ\hat{r}ₜ*_{, c}_{ᵤ} |
| Unknown (uncertainty) | Ω = [symbol] ∪ [symbol] | z(Ω) = 0 |

The factors αₜ and αᵣ serve as sensor-dependent hyperparameters.

By way of illustration, the following results for FOD ω:

$$Ω {=}^{def} \{ \underline{free} , unknowm object class , {\underbrace{{c}_{1} , {c}_{2} , … , {c}_{C}}}_{C annotated object type object classes} \} {=}^{def} \{ f , u , {c}_{1} , {c}_{2} , … , {c}_{C} \} .$$

According to various aspects, the particular belief, bel, of any hypothesis can be ascertained taking into account contradictions, for example using:
supporting measurements: if hypothesis A is a subset of another hypothesis B, additional measurements for A can result in a high belief for B. Example: a measurement of type “car” supports the “occupied” hypothesis because the “car” hypothesis is a subset of the “occupied” hypothesis.
conflicting measurements: if hypothesis A is disjoint with respect to another hypothesis B, the measurements for A may conflict with hypothesis B, and the belief for B should be low. Example: a measurement of the type “free” conflicts with the “occupied” hypothesis, because the “free” hypothesis is disjoint with respect to the “occupied” hypothesis. The belief in being occupied is reduced.
irrelevant measurements: if a hypothesis A is neither a subset nor disjoint with respect to a hypothesis B (e.g., B is a subset of A), measurements of A have no influence on hypothesis B. Example: a measurement of the type “occupied” has no influence on the belief in the type “car,” because the “occupied” hypothesis is neither a subset nor disjoint with respect to the hypothesis “car.”

According to different aspects, the relation between a particular hypothesis w and any other hypothesis X can be evaluated in order to assign a measurement z(X) to the set of contradictory, supporting or irrelevant measurements according to:

$$\begin{matrix}bel ( ω ) = ( 1 - exp ( - {\underbrace{{\sum }_{X ⊆ ω} Z ( X )}}_{supporting measurements} ) ) exp ( - {\underbrace{{\sum }_{X ⋂ ω = ∅} Z ( X )}}_{conflicting measurements} ) \\ = ( 1 - {\prod }_{X ⊆ ω} {e}^{- z ( X )} ) {\prod }_{X ⋂ ω = ∅} {e}^{- z ( X )} for ω ⊂ Ω\end{matrix}$$

Because irrelevant measurements do not contribute to the belief in a hypothesis, they can be omitted from the equation. Furthermore, the belief in ω=Ω is, by definition, equal to one.

The belief mass of each of the N hypotheses Ω_{n=1 bis N} can be taken into account. The sum of these can be modeled according to:

$$b = ( \begin{matrix}bel ( {ω}_{1} ) \\ bel ( {ω}_{2} ) \\ ⋮ \\ bel ( {ω}_{n} )\end{matrix} ) = S ( \begin{matrix}m ( {ω}_{1} ) \\ m ( {ω}_{2} ) \\ ⋮ \\ m ( {ω}_{n} )\end{matrix} ) = Sm \text{} with \text{} \begin{matrix}S ∈ {ℝ}^{n \times n} : {S}_{ij} = \{ \begin{matrix}1 & if {ω}_{j} ⊆ {ω}_{i} \\ 0 & otherwise\end{matrix} \\ m ∈ {ℝ}^{n} : belief vector\end{matrix}$$

Matrix S can be defined, for example, according to

S∈ [symbol] :Sᵢⱼ=1{ωⱼ⊆ωᵢ}, where

$$S = \begin{matrix}ℱ \\ {ℒ}_{1} \\ ⋮ \\ {ℒ}_{C} \\ 𝒰 \\ 𝒪 \\ Ω\end{matrix} \begin{matrix}\begin{matrix}ℱ & {ℒ}_{1} & … & {ℒ}_{C} & 𝒰 & 𝒪 & Ω\end{matrix} \\ [ \begin{matrix}1 & 0 & 0 & 0 & 0 & 0 & 0 \\ 0 & 1 & 0 & 0 & 0 & 0 & 0 \\ 0 & 0 & ⋱ & 0 & 0 & 0 & 0 \\ 0 & 0 & 0 & 1 & 0 & 0 & 0 \\ 0 & 0 & 0 & 0 & 1 & 0 & 0 \\ 0 & 1 & 1 & 1 & 1 & 1 & 0 \\ 1 & 1 & 1 & 1 & 1 & 1 & 1\end{matrix} ]\end{matrix}$$

The belief vector m can comprise the belief masses m(ωⱼ) of all hypotheses. For example, matrix S can be invertible, whereby belief vector m can be ascertained according to m=S⁻¹b.

According to various aspects, for each voxel, (x,y,z), a particular plausibility, pl, can be ascertained for each object type object class, cᵢ. If the voxel, (x,y,z), is occupied by an object (i.e., pl( [symbol] )>pl( [symbol] ), the object type object class, cᵢ, having the greatest plausibility as object type c(x,y,z) of the voxel, (x,y,z), is ascertained. Otherwise, the voxel, (x,y,z), has the free state. Consequently, the object type of a voxel, (x,y,z), can be ascertained according to:

$$c ( x , y , z ) = \{ \begin{matrix}{arg max pl ( {ℒ}_{j} )}_{{ℒ}_{j}} & if pl ( 𝒪 ) > pl ( ℱ ) \\ ℱ & otherwise\end{matrix}$$

By way of illustration, the method 200 described herein allows a ground truth occupancy grid map to be generated based on sparse, only partially annotated LIDAR data.

According to various aspects, a machine learning model configured to output an occupancy grid map in response to an input of camera images can be trained using the generated training data (i.e., the semantic ground truth occupancy grid maps generated by means of the method 200). For this purpose, camera images representing the (dynamic) surrounding area of the robot device at the reference point in time (e.g., in a panoramic view) can be provided. The machine learning model can then be trained using the camera images as input and the ground truth occupancy grid map as ground truth output.

It is understood that the achieved accuracy of the machine learning model trained in this way is achieved by the training data generated by means of the method 200 and that no change in the architecture of the machine learning model is required. For example, the semantic ground truth occupancy grid maps generated by means of the method 200 are significantly more accurate than semantic occupancy grid maps generated using other methods.

A method for controlling a robot (e.g., the vehicle 100 or another robot device) can comprise capturing camera images (e.g., using cameras 110) (at a point in time t). These camera images can then be fed into the trained machine learning model to generate an associated occupancy grid map (associated with the point in time t). The method for controlling the robot can then comprise ascertaining a control trajectory for controlling the robot device by using the generated occupancy grid map, and can comprise controlling the robot (e.g., the vehicle 100) according to the control trajectory.

By way of illustration, the at least one LIDAR sensor 109 can be used to generate the plurality of annotated LIDAR point clouds representing the (dynamic) surrounding area of the vehicle 100, but it is no longer required after training the machine learning model. By way of illustration, the vehicle 100, when using the trained machine learning model, can be operated without the LIDAR sensor 109 but with the cameras 110.

Although in the above statements the approach of FIG. 2 is described in various aspects with respect to the vehicle 100, said approach can generally be used to generate training data for a machine learning model that is intended to detect objects in the surrounding area of an arbitrary (e.g., dynamic) technical system, e.g., a computer-controlled machine such as a robot, a vehicle, a household appliance, a power tool, a manufacturing machine, a personal assistant or an access control system, etc. (e.g., based on images).

1-10. (canceled)

11. A method for generating training data for a machine learning model, the method comprising the following steps:
providing a plurality of annotated LIDAR point clouds representing a surrounding area of a robot device, each of the annotated LIDAR point clouds being assigned to a point in time of a plurality of successive points in time, wherein each point of each of the annotated LIDAR point clouds represents a particular object class of a plurality of object classes;
for each annotated LIDAR point cloud of the plurality of annotated LIDAR point clouds: ascertaining a respective transmission grid map in spherical coordinate space, wherein each voxel of the respective transmission grid map indicates how many rays pass through the voxel before being reflected at a point of the annotated LIDAR point cloud;
ascertaining a reference transmission grid map in Cartesian coordinate space assigned to a reference point in time of the plurality of points in time by: transforming the voxels of each of the respective transmission grid maps by using motion information indicating how objects represented by the plurality of annotated LIDAR point clouds move at the successive points in time such that a position of the voxels corresponds to a position at the reference point in time, and by transforming the voxels of each of the respective transmission grid maps from spherical coordinate space to Cartesian coordinate space, wherein each voxel of the reference transmission grid map indicates how many rays pass through the voxel on average before the rays are reflected;
for each object class of the plurality of object classes:
for each annotated LIDAR point cloud of the plurality of annotated LIDAR point clouds, ascertaining a reflection grid map associated with the object class, wherein each voxel of the reflection grid map indicates how many points representing the object class are arranged in the voxel,
ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming the voxels of each reflection grid map associated with the object class from spherical coordinate space into Cartesian coordinate space, wherein each voxel of the object class-specific reference reflection grid map indicates how many points representing the object class are arranged on average in the voxel; and
ascertaining, by using the reference transmission grid map and each of the object class-specific reference reflection grid maps, a ground truth occupancy grid map using evidence theory, wherein each voxel of the ground truth occupancy grid map indicates whether the voxel is occupied by an object and, when the voxel is occupied by an object, indicates the object class.

12. The method according to claim 11, wherein:
one object class of the plurality of object classes indicates that an object type is unknown, and each other object class of the plurality of object classes indicates a particular object type; and
when a voxel of the ground truth occupancy grid map is occupied by an object, the voxel indicates the object type.

13. The method according to claim 11, wherein the transformation from spherical coordinate space to Cartesian coordinate space includes, for each voxel:
normalizing a number indicated by the voxel to a ratio between a volume of the voxel in spherical coordinate space and a volume of the voxel in Cartesian coordinate space.

14. The method according to claim 11, wherein the ascertaining of the ground truth occupancy grid map using evidence theory includes:
ascertaining the ground truth occupancy grid map using evidence theory with a particular hypothesis for: each object class of the plurality of object classes, a free state, an occupied state, and an uncertainty.

15. The method according to claim 12, wherein the ascertaining of the ground truth occupancy grid map using evidence theory for each voxel includes:
ascertaining a particular plausibility for each of the other object classes of the plurality of object classes;
ascertaining whether the voxel is occupied by an object or not; and
when it is ascertained that the voxel is occupied by an object, ascertaining the other object class having the greatest plausibility as the object class indicated by the voxel.

16. A method for training a machine learning model configured to, in response to an input of camera images, output an occupancy grid map, the method comprising the following steps:
generating a ground truth occupancy grid map by performing:
providing a plurality of annotated LIDAR point clouds representing a surrounding area of a robot device, each of the annotated LIDAR point clouds being assigned to a point in time of a plurality of successive points in time, wherein each point of each of the annotated LIDAR point clouds represents a particular object class of a plurality of object classes;
for each annotated LIDAR point cloud of the plurality of annotated LIDAR point clouds: ascertaining a respective transmission grid map in spherical coordinate space, wherein each voxel of the respective transmission grid map indicates how many rays pass through the voxel before being reflected at a point of the annotated LIDAR point cloud;
ascertaining a reference transmission grid map in Cartesian coordinate space assigned to a reference point in time of the plurality of points in time by: transforming the voxels of each of the respective transmission grid maps by using motion information indicating how objects represented by the plurality of annotated LIDAR point clouds move at the successive points in time such that a position of the voxels corresponds to a position at the reference point in time, and by transforming the voxels of each of the respective transmission grid maps from spherical coordinate space to Cartesian coordinate space, wherein each voxel of the reference transmission grid map indicates how many rays pass through the voxel on average before the rays are reflected;
for each object class of the plurality of object classes:
for each annotated LIDAR point cloud of the plurality of annotated LIDAR point clouds, ascertaining a reflection grid map associated with the object class, wherein each voxel of the reflection grid map indicates how many points representing the object class are arranged in the voxel,
ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming the voxels of each reflection grid map associated with the object class from spherical coordinate space into Cartesian coordinate space, wherein each voxel of the object class-specific reference reflection grid map indicates how many points representing the object class are arranged on average in the voxel; and
ascertaining, by using the reference transmission grid map and each of the object class-specific reference reflection grid maps, a ground truth occupancy grid map using evidence theory, wherein each voxel of the ground truth occupancy grid map indicates whether the voxel is occupied by an object and, when the voxel is occupied by an object, indicates the object class;
providing camera images representing a surrounding area of a robot device at the reference point in time; and
training the machine learning model by using the camera images as input and the ground truth occupancy grid map as ground truth output.

17. A control device, configured to:
receive camera images representing a surrounding area of the robot device;
ascertain an occupancy grid map of the surrounding area of the robot device by using the machine learning model trained by:
generating a ground truth occupancy grid map by performing:
providing a plurality of annotated LIDAR point clouds representing a surrounding area of a robot device, each of the annotated LIDAR point clouds being assigned to a point in time of a plurality of successive points in time, wherein each point of each of the annotated LIDAR point clouds represents a particular object class of a plurality of object classes;
for each annotated LIDAR point cloud of the plurality of annotated LIDAR point clouds: ascertaining a respective transmission grid map in spherical coordinate space, wherein each voxel of the respective transmission grid map indicates how many rays pass through the voxel before being reflected at a point of the annotated LIDAR point cloud;
ascertaining a reference transmission grid map in Cartesian coordinate space assigned to a reference point in time of the plurality of points in time by: transforming the voxels of each of the respective transmission grid maps by using motion information indicating how objects represented by the plurality of annotated LIDAR point clouds move at the successive points in time such that a position of the voxels corresponds to a position at the reference point in time, and by transforming the voxels of each of the respective transmission grid maps from spherical coordinate space to Cartesian coordinate space, wherein each voxel of the reference transmission grid map indicates how many rays pass through the voxel on average before the rays are reflected;
for each object class of the plurality of object classes:
for each annotated LIDAR point cloud of the plurality of annotated LIDAR point clouds, ascertaining a reflection grid map associated with the object class, wherein each voxel of the reflection grid map indicates how many points representing the object class are arranged in the voxel,
ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming the voxels of each reflection grid map associated with the object class from spherical coordinate space into Cartesian coordinate space, wherein each voxel of the object class-specific reference reflection grid map indicates how many points representing the object class are arranged on average in the voxel; and
ascertaining, by using the reference transmission grid map and each of the object class-specific reference reflection grid maps, a ground truth occupancy grid map using evidence theory, wherein each voxel of the ground truth occupancy grid map indicates whether the voxel is occupied by an object and, when the voxel is occupied by an object, indicates the object class;
providing second camera images representing a surrounding area of a second robot device at the reference point in time; and
training the machine learning model by using the camera images as input and the ground truth occupancy grid map as ground truth output;
ascertain, by using the occupancy grid map, a control trajectory for controlling the robot device; and
control the robot device according to the control trajectory.

18. A robot device, comprising:
a control device configured to:
receive camera images representing a surrounding area of the robot device;
ascertain an occupancy grid map of the surrounding area of the robot device by using the machine learning model trained by:
generating a ground truth occupancy grid map by performing:
providing a plurality of annotated LIDAR point clouds representing a surrounding area of a robot device, each of the annotated LIDAR point clouds being assigned to a point in time of a plurality of successive points in time, wherein each point of each of the annotated LIDAR point clouds represents a particular object class of a plurality of object classes;
for each annotated LIDAR point cloud of the plurality of annotated LIDAR point clouds: ascertaining a respective transmission grid map in spherical coordinate space, wherein each voxel of the respective transmission grid map indicates how many rays pass through the voxel before being reflected at a point of the annotated LIDAR point cloud;
ascertaining a reference transmission grid map in Cartesian coordinate space assigned to a reference point in time of the plurality of points in time by: transforming the voxels of each of the respective transmission grid maps by using motion information indicating how objects represented by the plurality of annotated LIDAR point clouds move at the successive points in time such that a position of the voxels corresponds to a position at the reference point in time, and by transforming the voxels of each of the respective transmission grid maps from spherical coordinate space to Cartesian coordinate space, wherein each voxel of the reference transmission grid map indicates how many rays pass through the voxel on average before the rays are reflected;
for each object class of the plurality of object classes:
for each annotated LIDAR point cloud of the plurality of annotated LIDAR point clouds, ascertaining a reflection grid map associated with the object class, wherein each voxel of the reflection grid map indicates how many points representing the object class are arranged in the voxel,
ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming the voxels of each reflection grid map associated with the object class from spherical coordinate space into Cartesian coordinate space, wherein each voxel of the object class-specific reference reflection grid map indicates how many points representing the object class are arranged on average in the voxel; and
ascertaining, by using the reference transmission grid map and each of the object class-specific reference reflection grid maps, a ground truth occupancy grid map using evidence theory, wherein each voxel of the ground truth occupancy grid map indicates whether the voxel is occupied by an object and, when the voxel is occupied by an object, indicates the object class;
providing second camera images representing a surrounding area of a second robot device at the reference point in time; and
training the machine learning model by using the camera images as input and the ground truth occupancy grid map as ground truth output;
ascertain, by using the occupancy grid map, a control trajectory for controlling the robot device; and
control the robot device according to the control trajectory; and
a plurality of cameras configured to capture the camera mages.

19. A non-transitory computer-readable medium on which is stored commands for generating training data for a machine learning model, the commands, when executed by a processor, causing the processor to perform the following steps:
providing a plurality of annotated LIDAR point clouds representing a surrounding area of a robot device, each of the annotated LIDAR point clouds being assigned to a point in time of a plurality of successive points in time, wherein each point of each of the annotated LIDAR point clouds represents a particular object class of a plurality of object classes;
for each annotated LIDAR point cloud of the plurality of annotated LIDAR point clouds: ascertaining a respective transmission grid map in spherical coordinate space, wherein each voxel of the respective transmission grid map indicates how many rays pass through the voxel before being reflected at a point of the annotated LIDAR point cloud;
ascertaining a reference transmission grid map in Cartesian coordinate space assigned to a reference point in time of the plurality of points in time by: transforming the voxels of each of the respective transmission grid maps by using motion information indicating how objects represented by the plurality of annotated LIDAR point clouds move at the successive points in time such that a position of the voxels corresponds to a position at the reference point in time, and by transforming the voxels of each of the respective transmission grid maps from spherical coordinate space to Cartesian coordinate space, wherein each voxel of the reference transmission grid map indicates how many rays pass through the voxel on average before the rays are reflected;
for each object class of the plurality of object classes:
for each annotated LIDAR point cloud of the plurality of annotated LIDAR point clouds, ascertaining a reflection grid map associated with the object class, wherein each voxel of the reflection grid map indicates how many points representing the object class are arranged in the voxel,
ascertaining an object class-specific reference reflection grid map in Cartesian coordinate space assigned to the reference point in time by: transforming the voxels of each reflection grid map associated with the object class by using the motion information such that the position of said voxels corresponds to the position at the reference point in time, and by transforming the voxels of each reflection grid map associated with the object class from spherical coordinate space into Cartesian coordinate space, wherein each voxel of the object class-specific reference reflection grid map indicates how many points representing the object class are arranged on average in the voxel; and
ascertaining, by using the reference transmission grid map and each of the object class-specific reference reflection grid maps, a ground truth occupancy grid map using evidence theory, wherein each voxel of the ground truth occupancy grid map indicates whether the voxel is occupied by an object and, when the voxel is occupied by an object, indicates the object class.
